(19) United States
(12) Patent Application Publication
(10) Pub. No.: US 2023/0295000 A1
(43) Pub. Date: Sep. 21, 2023

(54) METHOD FOR PREPARING PEROVSKITE NANOPOWDER THROUGH A RHEOLOGICAL PHASE REACTION AT LOW-TEMPERATURE

(71) Applicant: XinJiang Technical Institute of Physics & Chemistry, Chinese Academy of Sciences, Urumqi (CN)

(72) Inventors: Pengjun ZHAO, Urumqi (CN); Lin LIU, Urumqi (CN); Yueqi ZHOU, Urumqi (CN); Renhao ZHENG, Urumqi (CN); Aimin CHANG, Urumqi (CN); Huimin ZHANG, Urumqi (CN); Yongxin XIE, Urumqi (CN)

(73) Assignee: XinJiang Technical Institute of Physics & Chemistry, Chinese Academy of Sciences, Urumqi (CN)

(21) Appl. No.: 18/182,033

(22) Filed: Mar. 10, 2023

(30) Foreign Application Priority Data
Mar. 18, 2022 (CN) 2022102701994

(51) Int. Cl. C01G 23/00; B82Y 40/00

(52) U.S. Cl. CPC C01G 23/006; B82Y 40/00; C01P 2004/61

(57) ABSTRACT

A method for preparing perovskite nanopowder through a rheological phase reaction at low-temperature that can include: taking hydroxide and metallorganic compound as initial reactants; mixing and stirring the reaction raw materials to form a solid-liquid rheological phase mixture; and controlling the reaction temperature and period, under a low-temperature condition, to prepare perovskite nanopowder in nearly spherical shape and a size of 20-100 nm. This allows for advantages such as controllable product size, low cost, high yield per unit volume, environmental friendliness, high yield per unit volume, and high repeatability. The perovskite nanopowder obtained by this way is nearly spherical, are uniform in size distribution and have controllable granularity. This can be used as the ceramic substrate for electronic components such as high-end chip capacitors and PTC thermistors, etc., as well as the raw material for manufacturing ceramic 3D printing additives and electronic ceramic ink.

### TECHNICAL FIELD

The invention relates to a method for preparing perovskite nanopowder through a rheological phase reaction at low-temperature.

### BACKGROUND ART

Perovskite phase material (ABO₃), as one of the most widely used electronic ceramics materials, is applicated extensively in many fields such as multilayer chip ceramic capacitors, positive temperature coefficient thermistors, composite ceramic fillers and others. It is known as the mainstay in electronic ceramic industry. As higher controlling accuracy has been required in modern advanced manufacturing industry, as well as preparation for ceramic 3D printing additives and electronic ceramic ink has been highly demanded, further requirements have been set forth for the nanometerization of ceramic precursor materials. At present, to manufacture large quantities of perovskite powder materials in the industry, a high-temperature solid-phase method is used commonly, in which metal oxide is used as the raw material. However, this method has obvious defects in modern industrial technology. For example, the calcination temperature of the precursor is quite high, causing high energy consumption; powder particle sizes are uneven, causing difficulties to ensure quality consistency; particle sizes are generally larger than 100 nm; and powder activity is low. Therefore, this method has certain limitations, and barely meets the requirements for modern manufacturing. Till now, in the world, only a few companies (such as Sakai Chemical Industry, Japan, which monopolizes more than 90% of the global market of nano-scale barium titanate powder) can provide nano-scale perovskite powder in industrialized large-scale. These companies mainly adopt liquid-phase hydrothermal method, which causes relatively high equipment costs, utilization of massive liquid-phase medium and anti-agglomeration agent in the preparation process, low product yield per unit volume, and poor production efficiency.

In view of the situation of the increasing demand for perovskite phase material nano-powder in advanced electronic industry markets, especially for the 3D printing ceramic additives manufacturing and electronic ceramic ink, as well as their high technical barriers, the present invention provides a method, in which liquid metallorganic compound (B-position metal source) and hydroxide (A-position metal source) are stirred directly at room temperature to make a mixture slurry; and the rheological phase mixture is transferred to a sealed reactor, then spherical nanopower are prepared by controlling the temperature and period of the solid-liquid reaction. In the preparation process, the organometallic compound and the hydroxide undergo an in-situ hydrolysis reaction to finally generate perovskite nanopowder. The invention has many advantages, such as simple process, low reaction temperature, environmental friendliness, high yield per unit volume, low cost, etc. The perovskite phase nanopowder prepared by the invention are nearly spherical, in uniform size distribution and controllable particle size, thus can be used as the ceramic substrate raw materials for electronic components such as high-end chip ceramic capacitors and PTC thermistors, etc., as well as 3D printing additive or electronic ceramic ink.

### SUMMARY OF THE INVENTION

The purpose of the present invention is to provide a method for preparing perovskite nanopowder through a rheological phase reaction at low-temperature. In the method, hydroxide and metallorganic compound, as starting reactants, are mixed and stirred to form a solid-liquid rheological phase mixture; by controlling the reaction temperature and period, near-spherical perovskite nanopowder in a size of 20-100 nm are obtained under a low-temperature condition. The method has the advantages of controllable product size, low cost, high yield per unit volume, environmental friendliness, high repeatability and the like. Therefore, it can be used in the fields for manufacturing chip ceramic capacitors, PTC thermistors, composite ceramic substrate, ceramic additives and electronic ceramic ink, etc.

In the method for preparing perovskite nanopowder through a rheological phase reaction at low-temperature according to the present invention, hydroxide and metallorganic compound, as starting reactants, are mixed and stirred to form a solid-liquid rheological mixture; by controlling the reaction temperature and period, multinary oxide perovskite nano powder in a uniform size is obtained under a low-temperature condition. The method is carried out as the following specific operation steps of:
a. placing first barium hydroxide, barium hydroxide monohydrate, barium hydroxide octahydrate, calcium hydroxide or lead hydroxide octahydrate, and then metallorganic compound tetrabutyl titanate, tetrabutyl zirconate, titanium isopropoxide or zirconium isopropoxide, in a molar ratio of 1:1, into a beaker, stirring for 30 min, and mixing well to form a uniform rheological phase mixture;
or placing first barium hydroxide monohydrate, barium hydroxide octahydrate, calcium hydroxide or lead hydroxide octahydrate, and then metallorganic compounds tetrabutyl titanate and tetrabutyl zirconate, or titanium isopropoxide and tetrabutyl zirconate, in a molar ratio of 1:0.2-0.8:0.2-0.8, into a beaker, stirring for 30 min, and mixing well to form a uniform rheological phase mixture;
b. transferring the rheological phase mixture obtained in step a into a sealed reactor, wherein the mixture occupies 10-80% of the sealed reactor's volume;
c. placing the sealed reactor of step b in an incubator to allow the mixture to react at a low temperature, wherein the reaction temperature is 80-160° C., and the reaction period is 0.5-15 h;
d. washing the product obtained in step c with 0.05-0.2 mol/L dilute hydrochloric acid for 3 times, and dispersing the washed product into a centrifuge tube with deionized water or absolute ethanol as the dispersion medium, wherein the centrifuge is rotated at a speed of 3000-5000 r/min, for 10-30 min each time and 3-5 times repeatedly; then placing the centrifuge tube in a vacuum oven to dry for 24 h to obtain monodisperse near-spherical binary or multinary metal oxide perovskite phase nanopowder in a size of 20-100 nm.

The perovskite nanopowder obtained by the method of the invention are expected to be utilized as the ceramic substrate raw materials for electronic components such as high-end chip ceramic capacitors and PTC thermistors, etc.

Considering the demand for barium titanate nano-powder in the industrial field, the present invention provides a method for preparing perovskite nanopowder through a rheological phase reaction at low-temperature. The method has the advantages of low cost, simple process, environmental friendliness, small particle size, adjustable morphology and composition, uniform size distribution, and good crystallinity, etc.

The method for preparing perovskite nanopowder through a rheological phase reaction at low-temperature according to the present invention is unique in the following aspects:
as compared with a solid-phase reaction, its preparation process is carried out entirely at a milder temperature, i.e., lower than 200° C., which saves massive energy and reduces the production cost;
its yield is extremely high (with the same volume of the container), i.e., hundreds or even thousands of times higher than that of a liquid-phase reaction (hydrothermal, sol-gel method, co-precipitation method, etc.), which improves the production efficiency;
the prepared nano-powder is uniform in size, nearly monodisperse, and the product size can be modified by adjusting the reaction parameters;
besides basic hydroxides and metallorganic compounds, no other substances are involved in the entire reaction process, thus the prepared nano-powder has high purity and low impurity content.

The perovskite phase nanopowder prepared by the present invention are utilized in:
applications of high-end chip ceramic capacitors; PTC thermistors; composite ceramic substrate; electric vehicle power supply; 3D printing additive manufacturing; and electronic ceramics ink preparation.

### DESCRIPTION OF DRAWINGS

FIG. 1 is the XRD pattern of the barium titanate (BaTiO₃) nanopowder prepared by the present invention, showing that it is a single perovskite phase;

FIG. 2 is the scanning electron microscope picture of the barium titanate(BaTiO₃) nanopowder prepared by the present invention.

### SPECIFIC MODES FOR CARRYING OUT THE INVENTION

### EXAMPLE 1

a. First lead hydroxide octahydrate and then metallorganic compound zirconium isopropoxide were placed into a beaker at a molar ratio of 1:1, stirred for 30 min, and mixed well to form a uniform rheological phase mixture;

b. The rheological phase mixture obtained in step a was transferred to a sealed reactor, wherein the mixture occupied 10% of the sealed reactor's volume;

c. The sealed reactor of step b was placed in an incubator to allow the mixture to react at a low temperature, wherein the reaction temperature was 80° C., and the reaction period was 15 h;

d. The product obtained in step c was washed 3 times with 0.05mol/L dilute hydrochloric acid, dispersed into a centrifuge tube with absolute ethanol as the dispersion medium, wherein the centrifuge was rotated at a speed of 3000 r/min, for 20 min each time and 5 times repeatedly; the centrifuge tube was placed in a vacuum oven to dry for 24 h to obtain monodisperse near-spherical perovskite-phase lead zirconate (PbZrO₃) nanopowder in a size of 50 nm.

### EXAMPLE 2

a. First barium hydroxide octahydrate and then metallorganic compound tetrabutyl titanate were placed into a beaker at a molar ratio of 1:1, stirred for 30 min, and mixed well to form a uniform rheological phase mixture;

b. The rheological phase mixture obtained in step a was transferred to a sealed reactor, wherein the mixture occupied 50% of the sealed reactor's volume;

c. The sealed reactor of step b was placed in an incubator to allow the mixture to react at a low temperature, wherein the reaction temperature was 120° C., and the reaction period was 2 h;

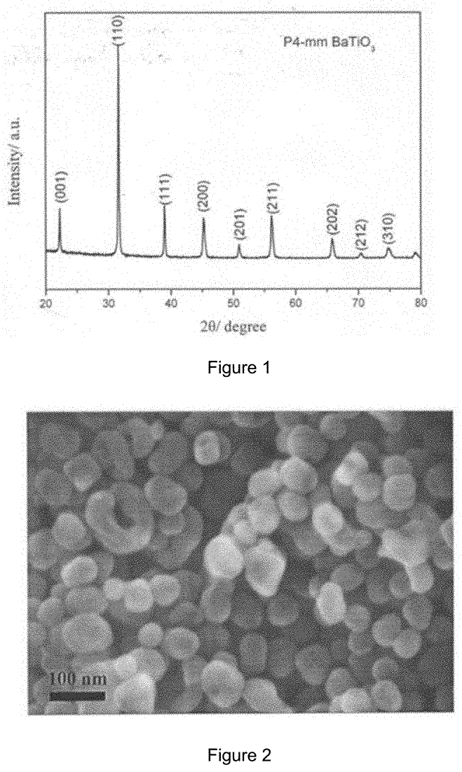

d. The product obtained in step c was washed 3 times with 0.1 mol/L dilute hydrochloric acid, dispersed into a centrifuge tube with deionized water as the dispersion medium, wherein the centrifuge was rotated at a speed of 4000 r/min, for 30 min each time and 5 times repeatedly; the centrifuge tube was placed in a vacuum oven to dry for 24 h to obtain monodisperse near-spherical perovskite-phase barium titanate (BaTiO₃) nanopowder (FIG. 1) in a size of 30 nm (FIG. 2).

### EXAMPLE 3

a. First barium hydroxide monohydrate and then metallorganic compound titanium isopropoxide were placed into a beaker at a molar ratio of 1:1, stirred for 30 min, and mixed well to form a uniform rheological phase mixture;

b. The rheological phase mixture obtained in step a was transferred to a sealed reactor, wherein the mixture occupied 80% of the sealed reactor's volume;

c. The sealed reactor of step b was placed in an incubator to allow the mixture to react at a low temperature, wherein the reaction temperature was 160° C., and the reaction period was 6 h;

d. The product obtained in step c was washed 3 times with 0.2 mol/L dilute hydrochloric acid, dispersed into a centrifuge tube with deionized water as the dispersion medium, wherein the centrifuge was rotated at a speed of 5000 r/min, for 30 min each time and 5 times repeatedly; the centrifuge tube was placed in a vacuum oven to dry for 24 h to obtain monodisperse near-spherical perovskite-phase barium titanate (BaTiO₃) nanopowder in a size of 100 nm.

### EXAMPLE 4

a. First barium hydroxide and then metallorganic compound tetrabutyl zirconate were placed into a beaker at a molar ratio of 1:1, stirred for 30 min, and mixed well to form a uniform rheological phase mixture;

b. The rheological phase mixture obtained in step a was transferred to a sealed reactor, wherein the mixture occupied 30% of the sealed reactor's volume;

c. The sealed reactor of step b was placed in an incubator to allow the mixture to react at a low temperature, wherein the reaction temperature was 100° C., and the reaction period was 8 h;

d. The product obtained in step c was washed 3 times with 0.15 mol/L dilute hydrochloric acid, dispersed into a centrifuge tube with absolute ethanol as the dispersion medium, wherein the centrifuge was rotated at a speed of 3500 r/min, for 15 min each time and 4 times repeatedly; the centrifuge tube was placed in a vacuum oven to dry for 24 h to obtain monodisperse near-spherical perovskite-phase barium zirconate (BaZrO₃) nanopowder in a size of 50 nm.

### EXAMPLE 5

a. First calcium hydroxide and then metallorganic compounds tetrabutyl titanate and tetrabutyl zirconate were placed into a beaker at a molar ratio of 1:0.5:0.5, stirred for 30 min, and mixed well to form a uniform rheological phase mixture;

b. The rheological phase mixture obtained in step a was transferred to a sealed reactor, wherein the mixture occupied 60% of the sealed reactor's volume;

c. The sealed reactor of step b was placed in an incubator to allow the mixture to react at a low temperature, wherein the reaction temperature was 120° C., and the reaction period was 0.5 h;

d. The product obtained in step c was washed 3 times with 0.12 mol/L dilute hydrochloric acid, dispersed into a centrifuge tube with deionized water as the dispersion medium, wherein the centrifuge was rotated at a speed of 4500 r/min, for 25 min each time and 5 times repeatedly; the centrifuge tube was placed in a vacuum oven to dry for 24 h to obtain monodisperse near-spherical perovskite-phase calcium zirconate-titanate (CaZr_{0.5}Ti_{0.5}O₃) nanopowder in a size of 80 nm.

### EXAMPLE 6

a. First calcium hydroxide and then metallorganic compounds tetrabutyl titanate and tetrabutyl zirconate were placed into a beaker at a molar ratio of 1:0.8:0.2, stirred for 30 min, and mixed well to form a uniform rheological phase mixture;

b. The rheological phase mixture obtained in step a was transferred to a sealed reactor, wherein the mixture occupied 50% of the sealed reactor's volume;

c. The sealed reactor of step b was placed in an incubator to allow the mixture to react at a low temperature, wherein the reaction temperature was 110° C., and the reaction period was 1.5 h;

d. The product obtained in step c was washed 3 times with 0.12 mol/L dilute hydrochloric acid, dispersed into a centrifuge tube with deionized water as the dispersion medium, wherein the centrifuge was rotated at a speed of 4500 r/min, for 25 min each time and 5 times repeatedly; the centrifuge tube was placed in a vacuum oven to dry for 24 h to obtain monodisperse near-spherical perovskite-phase calcium zirconate-titanate (CaZr_{0.2}Ti_{0.5}O₃) nanopowder in a size of 70 nm.

### EXAMPLE 7

a. First barium hydroxide monohydrate and then metallorganic compounds titanium isopropoxide and tetrabutyl zirconate were placed into a beaker at a molar ratio of 1:0.5:0.5, stirred for 30 min, and mixed well to form a uniform rheological phase mixture;

b. The rheological phase mixture obtained in step a was transferred to a sealed reactor, wherein the mixture occupied 70% of the sealed reactor's volume;

c. The sealed reactor of step b was placed in an incubator to allow the mixture to react at a low temperature, wherein the reaction temperature was 150° C., and the reaction period was 6 h;

d. The product obtained in step c was washed 3 times with 0.12 mol/L dilute hydrochloric acid, dispersed into a centrifuge tube with deionized water as the dispersion medium, wherein the centrifuge was rotated at a speed of 4500 r/min, for 25 min each time and 5 times repeatedly; the centrifuge tube was placed in a vacuum oven to dry for 24 h to obtain monodisperse near-spherical perovskite-phase barium zirconate-titanate (BaZr_{0.5}Ti_{0.5}O₃) nanopowder in a size of 90 nm.

### EXAMPLE 8

a. First lead hydroxide octahydrate and then metallorganic compounds tetrabutyl titanate and tetrabutyl zirconate were placed into a beaker at a molar ratio of 1:0.5:0.5, stirred for 30 min, and mixed well to form a uniform rheological phase mixture;

b. The rheological phase mixture obtained in step a was transferred to a sealed reactor, wherein the mixture occupied 60% of the sealed reactor's volume;

c. The sealed reactor of step b was placed in an incubator to allow the mixture to react at a low temperature, wherein the reaction temperature was 130° C., and the reaction period was 10 h;

d. The product obtained in step c was washed 3 times with 0.12 mol/L dilute hydrochloric acid, dispersed into a centrifuge tube with deionized water as the dispersion medium, wherein the centrifuge was rotated at a speed of 4500 r/min, for 25 min each time and 5 times repeatedly; the centrifuge tube was placed in a vacuum oven to dry for 24 h to obtain monodisperse near-spherical perovskite-phase lead zirconate-titanate (PbZr_{0.5}Ti_{0.5}O₃) nanopowder in a size of 60 nm.

1. A method for preparing perovskite nanopowder through a rheological phase reaction at low-temperature, wherein the hydroxide and metallorganic compound(s), as starting reactants, are mixed and stirred to form a solid-liquid rheological mixture; by controlling the reaction temperature and period, multinary oxide perovskite nano powder in uniform size is obtained under a low-temperature condition, comprising the following specific operation steps of:
a. placing first barium hydroxide, barium hydroxide monohydrate, barium hydroxide octahydrate, calcium hydroxide or lead hydroxide octahydrate and then metallorganic compound tetrabutyl titanate, tetrabutyl zirconate, titanium isopropoxide or zirconium isopropoxide, in a molar ratio of 1:1, into a beaker, stirring for 30 min, and mixing well to form a uniform rheological phase mixture; or placing first barium hydroxide monohydrate, barium hydroxide octahydrate, calcium hydroxide or lead hydroxide octahydrate and then metallorganic compounds tetrabutyl titanate and tetrabutyl zirconate, or titanium isopropoxide and tetrabutyl zirconate, in a molar ratio of 1:0.2-0.8:0.2-0.8, into a beaker, stirring for 30 min, and mixing well to form a uniform rheological phase mixture;
b. transferring the rheological phase mixture obtained in step a into a sealed reactor, wherein the mixture occupies 10-80% of the sealed reactor's volume;
c. placing the sealed reactor of step b in an incubator to allow the mixture to react at a low temperature, wherein the reaction temperature is 80-160° C., and the reaction period is 0.5-15 h;
d. washing the product obtained in step c with 0.05-0.2 mol/L dilute hydrochloric acid for 3 times, and dispersing the washed product into a centrifuge tube with deionized water or absolute ethanol as the dispersion medium, wherein the centrifuge is rotated at a speed of 3000-5000 r/min, for 10-30 min each time and 3-5 times repeatedly; then placing the centrifuge tube in a vacuum oven to dry for 24 h to obtain monodisperse near-spherical binary or multinary metal oxide perovskite phase nanopowder in a size of 20-100 nm.
